(19) United States
(12) Patent Application Publication
(10) Pub. No.: US 2020/0177537 A1
(43) Pub. Date: Jun. 4, 2020

(54) CONTROL SYSTEM AND CONTROL METHOD FOR SOCIAL NETWORK

(71) Applicant: INDUSTRIAL TECHNOLOGY RESEARCH INSTITUTE, Hsinchu (TW)

(72) Inventors: Chieh-Chih CHANG, Hsinchu City (TW); Chih-Chung KUO, Zhudong Township (TW); Shih-Chieh CHIEN, Taichung City (TW); Jian-Yung HUNG, Taipei City (TW); Cheng-Hsien LIN, Zhudong Township (TW)

(73) Assignee: INDUSTRIAL TECHNOLOGY RESEARCH INSTITUTE, Hsinchu (TW)

(21) Appl. No.: 16/557,774

(22) Filed: Aug. 30, 2019

(30) Foreign Application Priority Data
Dec. 4, 2018 (TW) 107143479

(51) Int. Cl. H04L 12/58; G06Q 50/00

(52) U.S. Cl. CPC H04L 51/32; G06Q 50/01; G06F 3/011; H04L 51/08; H04L 51/26; H04L 51/046

(57) ABSTRACT

A control system and a control method for a social network are provided. The control method includes following steps. Obtaining detection information. Analyzing status information of at least one social member according to the detection information. Condensing the status information according to a time interval to obtain condensed information. Summarizing the condensed information according to a summary priority score to obtain summary information. Displaying the summary information.

This application claims the benefit of Taiwan application Serial No. 107143479, filed Dec. 4, 2018, the disclosure of which is incorporated by reference herein in its entirety.

### TECHNICAL FIELD

The disclosure relates to a control system and a control method for a social network.

### BACKGROUND

While immersed in busy work schedules, modern people still have every intention of attending to the daily lives of family members. The elderlies and children are particularly the ones that need to be cared for. If environments or physical and mental conditions of family members can be automatically detected and made known to other family members in a social network, interactions between the two parties can be promoted.

However, there are numerous requirements that need to be taken into account for the development of the above social network, for example, the privacy of members, whether the members feel bothered, and how information contents are displayed—these are some of the factors decisive on current development directions.

### SUMMARY

The disclosure is directed to a control system and a control method for a social network.

According to one embodiment of the disclosure, a control method for a social network is provided. The control method includes obtaining detection information, analyzing status information of at least one social member according to the detection information, condensing the status information according to a time interval to obtain condensed information, summarizing the condensed information according to a summary priority score to obtain summary information, and displaying the summary information.

According to another embodiment of the disclosure, a control system for a social network is provided. The control system includes at least one detection unit, an analysis unit, a condensation unit, a summary unit and a display unit. The detection unit obtains detection information. The analyzing unit analyzes status information of at least one social member according to the detection information. The condensation unit condenses the status information according to a time interval to obtain condensed information. The summary unit summarizes the condensed information according to a summary priority score to obtain summary information. The display unit displays the summary information.

Embodiments are described in detail with the accompanying drawings below to better understand the above and other aspects of the disclosure.

### BRIEF DESCRIPTION OF THE DRAWINGS

FIG. 1 is a schematic diagram of a social network according to an embodiment;

FIG. 2 is a schematic diagram of a control system for a social network according to an embodiment;

FIG. 3 is a flowchart of a control method for a social network according to an embodiment;

FIG. 4 is a schematic diagram of condensed information according to an embodiment;

FIG. 5 is a schematic diagram of condensed information according to another embodiment;

FIG. 6 is a schematic diagram of condensed information according to another embodiment;

FIG. 7 is a schematic diagram of condensed information according to another embodiment;

FIG. 8 is a schematic diagram of a fuzzy membership function; and

FIG. 9 is a flowchart of a control method for a social network according to another embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Various embodiments are given below to describe a control system and a control method for a social network of the disclosure. In the present disclosure, a social member in the social network can present records of activities (including emotion states, lifestyles, special events, member conversations, and/or virtual interactions) by means of a virtual character in a virtual scene presented by multimedia. Further, a user can present information using a virtualized and/or metaphorical multimedia selected as desired, and present condensed information by a non-linearly scaled time axis.

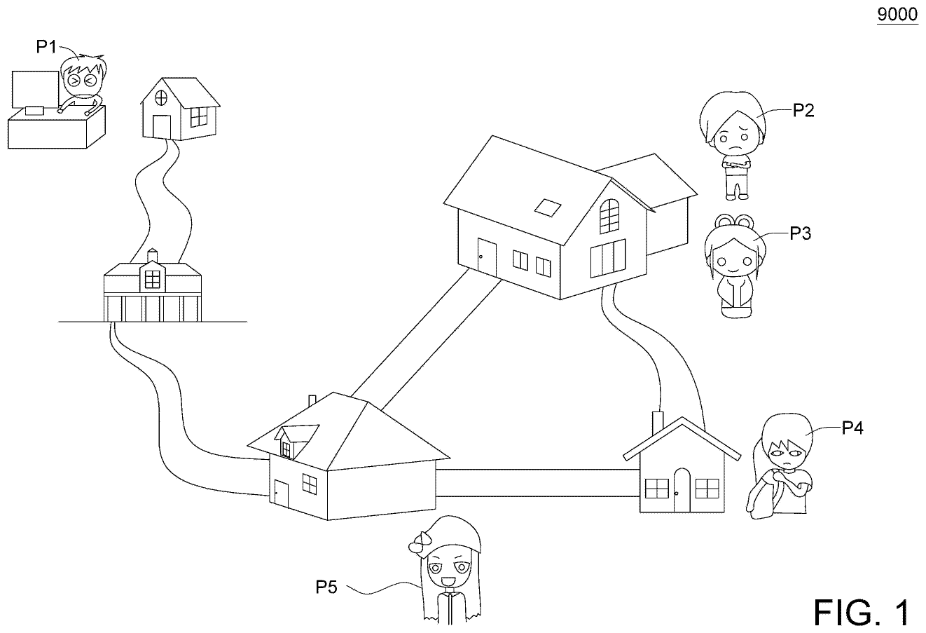

Refer to FIG. 1 showing a schematic diagram of a social network 9000 according to an embodiment. The social network 9000 can be joined by several social members P1 to P5, and presents the social members P1 to P5 in form of virtual characters. The social network 9000 can present emotion states, lifestyles, special events, member conversations, and/or virtual interactions of the social members P1 to P5. A user can select one of the social members P1 to P5 to further learn detailed information of the selected social member. In addition, the social network 9000 can further provide a function of initiative notification of special events or information correction. Detailed description is given with a flowchart(s) and a block diagram(s) below.

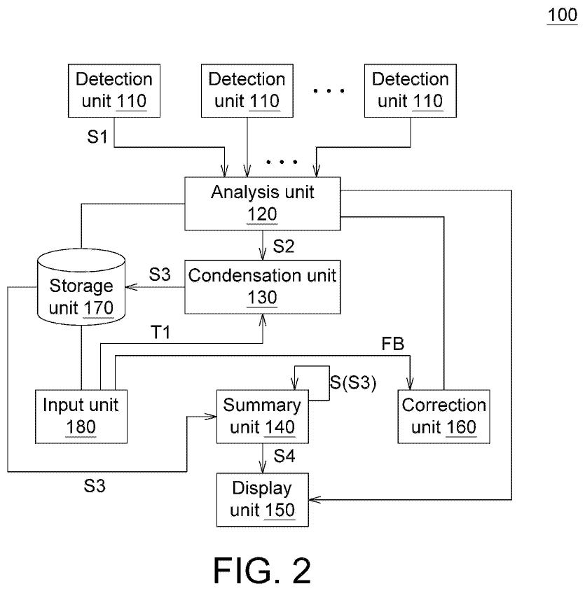

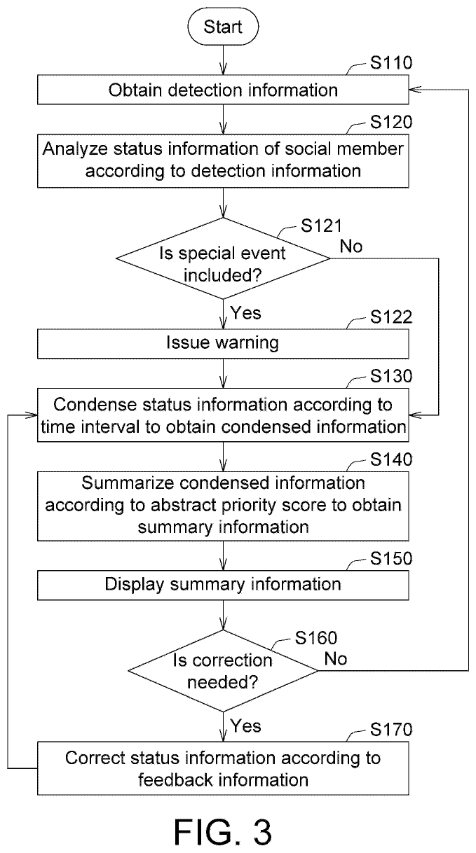

Refer to FIG. 2 and FIG. 3. FIG. 2 shows a schematic diagram of a control system 100 for the social network 9000 according to an embodiment. FIG. 3 shows a flowchart of a control method for the social network 9000 according to an embodiment. The control system 100 includes at least one detection unit 110, an analysis unit 120, a condensation unit 130, a summary unit 140, a display unit 150, a correction unit 160, a storage unit 170 and an input unit 180. The detection unit 110 is, for example, a contact detector or a non-contact detector. The analysis unit 120, the condensation unit 130, the summary unit 140 and the correction unit 160 are, for example, a circuit, a chip, a circuit board, a computer, a storage device storing one or more program codes, or a software program module. The display unit 150 is, for example, a liquid-crystal display (LCD), a television, a reporting device or a speaker. The storage unit 170 is, for example, a memory, a hard drive, or a cloud storage center. The input unit 180 is, for example, a touch panel, a wireless signal receiver, a connection port, a mouse, a stylus or a keyboard.

The components above can be integrated in the same electronic device, or be separately provided in different electronic devices. For example, the detection unit 110 can be discretely configured at different locations, the analysis unit 120, the concentration unit 130, the summary unit 140, the correction unit 160 and the storage unit 170 can be provided in a same host, and the display unit 150 can be a screen of a smartphone of a user.

Operations of the components above and various functions of the social network 9000 are described in detail with the flowchart below. In step S110 of FIG. 3, the detection unit 110 obtains detection information S1. The detection information S1 is, for example, a heartbeat frequency, a breathing frequency, a carbon monoxide concentration, a movement path, a body temperature, an image, a speech, an environmental sound, a humidity level or an air quality. The detection unit 110 can be configured at a fixed location, and is, for example, a wireless communication sensor, an infrared sensor, an ultrasonic sensor, a laser sensor, a visual sensor or an audio recognition device. The detection unit 110 configured at a fixed location corresponds to a predetermined scene, for example, the living room. The display unit 150 can display on the social network 9000 the background corresponding to the scene. The presentation of the background can be a predetermined virtual graph. When the detection unit 110 obtains the detection information S1, object identification or human face recognition can be further performed, and the identified object or social member can then be presented in form of a predetermined virtual image on the display unit 150.

The above detection unit 110 can also be a portable detector. When the detection unit 110 is placed in an environment, the detection information S1 can be used to determine details in the ambient environment. For example, the detection information S1 can be used to identify feature objects (e.g., television, bed or dining table) in the environment by identifying objects using the image recognition technology. Alternatively, the detection information S1 can be wireless signals of home appliances, and details of a located environment can be identified using home appliances having wireless communication capabilities.

In one embodiment, the social network 9000 can perform object identification or human face recognition, and present the identified object or social network in form of a predetermined virtual image on the display unit 150.

The detection unit 110 can also be worn on an autonomous mobile device. The autonomous mobile device can follow the movement of an object or a social member by an object tracking technique, and can also perform an autonomous movement by using the simultaneous localization and mapping (SLAM) technology. When the autonomous mobile device moves, the detection unit 110 can identify the ambient environment, and display the identified object or social member in form of a predetermined virtual image on the display unit 150. With the detection of the detection unit 110, a detected item can be presented in form of simulation in a virtual environment of the social network 9000.

The detection unit 110 can be a contact type or a non-contact type, and is, for example, a microphone, a video camera, an infrared temperature sensor, a humidity sensor, an ambient light sensor, a proximity sensor, a gravity sensor, an accelerometer sensor, a magnetism sensor, a gyroscope, a GPS sensor, a fingerprint sensor, a Hall sensor, a barometer, a heartrate sensor, a blood oxygen sensor, an infrared sensor or a Wi-Fi transceiving module.

The detection unit 110 can also be directly carried on various smart electronic devices, such as smart bracelets, smart earphones, smart glasses, smart watches, smart garments, smart rings, smart socks, smart shoes or heartbeat sensing belts.

Further, the detection unit 110 can also be a part of an electronic device, such as a part of a smart television, a surveillance camera, a game machine, a networked refrigerator or an antitheft system.

In step S120 in FIG. 3, the analysis unit 120 analyzes status information S2 of the social members P1 to P5 according to the detection information S1. The status information S2 is, for example, physical states, mental states (emotion states), living states (actions and lifestyles), special events or interaction states (member conversations and/or virtual interactions).

The status information S2 may be categorized into personal information, space information and/or special events. The personal information includes physiological states (physical states and/or mental states) and/or records of activity (personal activities and interaction activities). The space information includes environment states (temperature and/or humidity) and/or event and object records (turning on of a television and/or ringing doorbells). Special events are a general term for, for example, emergencies such as sudden shouting for help, earthquakes and abnormal sounds, and environmental events and abnormal events. The personal information and space information can be browsed on the social network 9000 by a user, and the special events can be notified to the user initiatively by the social network 9000.

More specifically, the detection unit 110 can use a wearable device to collect the temperatures, blood oxygen levels, heartbeats, calories burned, activities, locations and/or sleep information of social members as the detection information S1, use an infrared sensor to collect the temperatures of social members as the detection information S1, or use the non-contact radio sensing technology to collect human heartbeats as the detection information S1. The analysis unit 120 then analyzes the detection information S1 to obtain physical states as the status information S2. Means for the above detection and analysis can be real-time, non-contact, long-term and/or continuous detection and analysis, and functions including sensing, signal processing and/or wireless data transmission can be integrated by a smartphone.

Further, the analysis unit 120 can also analyze the detection information S1 in form of a speech to obtain physical states as the status information S2. For example, after the detection information S1 such as coughing, sneezing, snoring and/or sleep-talking is inputted into the analysis unit 120, the analysis unit 120 can analyze the detection information S1 according to frequency changes in events of snoring, teeth-grinding and/or coughing to obtain sleeping states as the status information S2.

Further, with images or audios as the detection information S1, the analysis unit 120 can also perform analysis to obtain emotion states (happiness, surprise, anger, dislike, sorrow, fear or neutral) of social members. The analysis unit 120 can identify current expression states by images and the human expression detection technology. After a social member is recognized by the speaker recognition technology, the analysis unit 120 can perform verbal sound analysis of voice emotion detection, emotion signification term detection and/or non-verbal sound emotion (e.g., laughter) detection, or consolidated processing and output can be performed by incorporating results of images and sounds. Alternatively, the analysis unit 120 can perform analysis on psychological related events such as self-talking and repeated conversation contents by using the detection information S1 in form of verbal sounds to obtain mental states as the status information S2.

The above detection and analysis operations can serve as warnings for states of dementia or abnormal behaviors. For example, through the detection information S1 including facial expressions, eye expressions, sounds and behaviors of a patient and/or walking postures, the analysis unit 120 can also perform analysis and obtain the status information S2 indicating any potential aggressive behavior. Taking sound detection for example, orientated by caretaking, the detection information S1 including verbal features, habits, use of terms and/or conversation contents of a social member is detected, and the analysis unit 120 then performs analysis by means of machine learning or deep learning algorithms to obtain the status information S2 indicating abnormal behaviors.

Further, the detection unit 110 can detect, via indoor positioning technology and activity analysis technology, information of a current location (e.g., dining room, bedroom, living room, study room or hallway) and activity information (e.g., dining, sleeping, watching television, reading, or falling on the ground) of a social member to obtain the detection information S1; the analysis unit 120 then uses machine learning or deep learning algorithms to further perform analysis according to the detection information S1 and time information to obtain the status information S2 indicating that the social member is currently, for example, dining.

Further, the detection unit 110 can obtain, from a third party, weather information or detect events of environment conditions (e.g., temperature, humidity, weather conditions, sound conditions, air quality and/or water level detection), sounds of glass, sounds of fireworks (gunshots), loud noises, high carbon monoxide levels and/or drowning, so as to further obtain the detection information S1 of the environment. The analysis unit 120 then uses machine learning or deep learning algorithms to perform analysis according to the detection information S1 to obtain the status information S2 of an environment where the social member is located.

Moreover, the detection unit 110 can obtain the detection information S1 in a streaming video/audio, and the analysis unit 120 then determines, for example, verbal activity sections and types, speaking scenarios (talking on the phone, conversing or non-conversing), the talking person, the duration, and/or the occurrence frequency of key terms according to the detection information S1, so as to generate consolidated status information S2 indicating the physiological states of a social member.

Alternatively, the analysis unit 120 can perform analysis according to contents, cries, shouts or calls in the detection information S1 to obtain the status information S2 indicating an argument event.

In step S121, if the analysis unit 120 determines that the status information S2 includes a special event, a warning is issued in step S122.

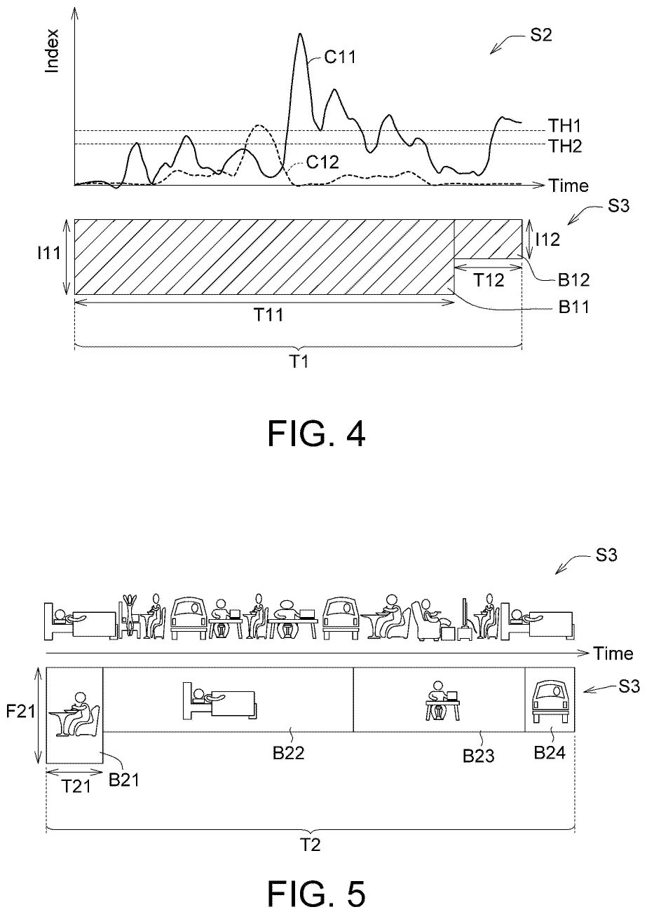

Next, in step S130 in FIG. 3, the condensation unit 130 condenses the status information S2 according to a time interval T1 to obtain condensed information S3. Refer to FIG. 4 showing a schematic diagram of the condensed information according to an embodiment. A user can enter a time interval T1 of interest to the condensation unit 130 by means of the input unit 180. The condensation unit 130 presents the condensed information S3 of the time interval T1 by a non-linearly scaled time axis, and the condensed information S3 is presented on the time axis according to the occurrence frequency and duration. Taking FIG. 4 for instance, the status information S2 includes a happiness index curve C11 and a surprise index curve C12. A social member is in a happy state when the happiness index curve C11 exceeds a threshold TH1, and is in a surprised state when the surprise index curve C12 exceeds the threshold TH2. The threshold TH1 and the threshold TH2 can be the same or different. The condensation unit 130 converts the happiness index curve C11 and the surprise index curve C12 in the time interval T1 into the condensed information S3. The condensed in formation S3 includes a condensed happiness block B11 and a condensed surprise block B12. The lengths on the two sides of the condensed happiness block B11 respectively represent an accumulated happiness time value T11 and an accumulated happiness index value 111, and the lengths on the two sides of the condensed surprise block B12 respectively represent an accumulated surprise time value T12 and an accumulated surprise index value 112. That is to say, after the conversion performed by the condensation unit 130, the accumulated duration of the happy state and the level of the happy state can be directly and intuitively observed from the lengths on the two sides of the condensed happiness block B11. Similarly, after the conversion performed by the condensation unit 130, the accumulated duration of the surprised state and the level of the surprised state can be directly and intuitively observed from the lengths on the two sides of the condensed surprise block B12. In one embodiment, the scaling ratio of the time axis can be determined according to the amount of a particular content of the status information S2 in the time interval. The amount of the content is, for example, the number of sets of the content, the variation level of the content along with time, the number of special events, or the amount of the content of interest of the user. Further, the condensed information S3 can also be sorted according to the accumulated index value of or the accumulated time value.

Refer to FIG. 5 showing a schematic diagram of the condensed information S3 according to another embodiment. Taking FIG. 5 for instance, the status information S2 indicating lifestyles include a sleeping state, a working state, a driving state or a dining state. The condensation unit 130 converts the sleeping state, working state, driving state or dining state in a time interval T2 into the condensed information S3. The condensed information S3 includes a condensed dining block B21, a condensed sleeping block B22, a condensed working block B23 and a condensed driving block B24. The lengths on the two sides of the condensed dining block B21 respectively represent an accumulated dining time value T21 and an accumulated dining frequency value F21. That is to say, after the conversion performed by the condensation unit 130, the accumulated duration of the dining state and the frequency of the dining state can be directly and intuitively observed from the lengths on the two sides of the condensed dining block B21. The condensed dining block B21, the condensed sleeping block B22, the condensed working block B23 and the condensed driving block B24 can be sorted according to the accumulated index value or the accumulated time value. Further, videos of lifestyles can also be condensed into a certain time interval in the condensed information S3 by a video technology.

Refer to FIG. 6 showing a schematic diagram of the condensed information S3 according to another embodiment. Taking FIG. 6 for instance, the condensed information S3 can also present virtual interaction contents. The virtual interaction contents are, for example, a happy emoji or an angry emoji. The concentration unit 130 converts the happy emoji or the angry emoji in a time interval T3 into the condensed information S3. The condensed information S3 includes a condensed happy block B31 and a condensed angry block B32. The lengths on the two sides of the condensed happy block B31 respectively represent an accumulated happy time value T31 and an accumulated happy frequency value F31. That is to say, after the conversion performed by the condensation unit 130, the accumulated duration of the happy state and the frequency of the happy state can be directly and intuitively observed from the lengths on the two sides of the condensed happy block B31. The condensed happy block B31 and the condensed angry block B32 can be sorted according to the accumulated index value or the accumulated time value. Further, the condensed information S3 also can be presented by a block diagram, a bubble diagram or other graphs capable of representing the accumulated frequency value and the accumulated time value.

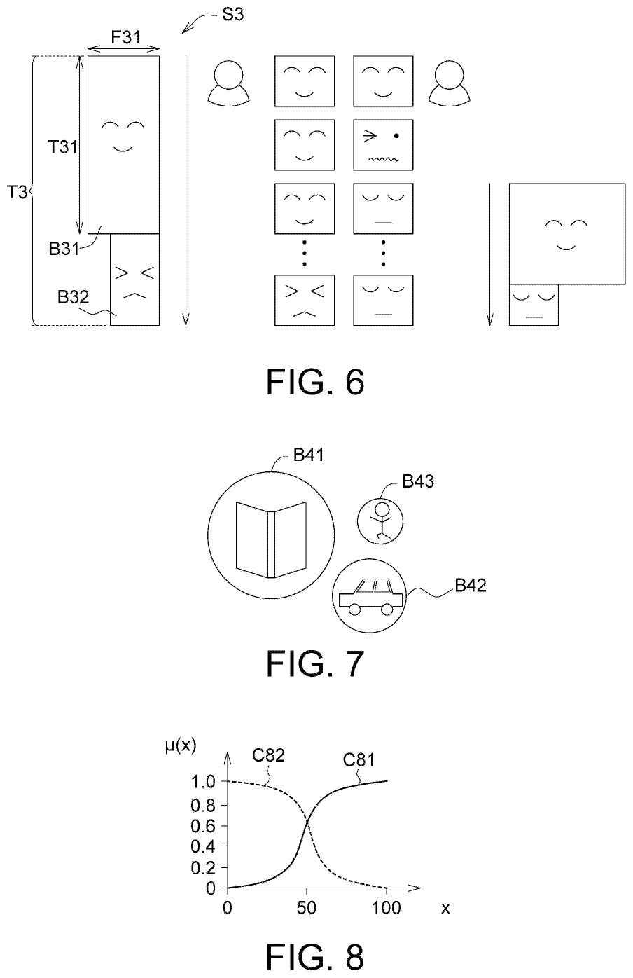

Refer to FIG. 7 showing a schematic diagram of the condensed information S3 according to another embodiment. Taking FIG. 7 for instance, the condensed information S3 can also be presented by means of a bubble diagram. The condensed information S3 includes a condensed studying block B41, a condensed driving block B42 and a condensed exercising block B43. The radius of the condensed studying block B41 represents an accumulated studying time value, and the size of the pattern in the condensed studying block B41 represents an accumulated studying frequency value. That is to say, after the conversion performed by the condensation unit 130, the accumulated duration of the studying state and the frequency of the studying state can be directly and intuitively observed from the radius and the size of the pattern in the condensed studying block B41.

In step S140 in FIG. 3, the summary unit 140 summarizes the condensed information S3 according to a summary priority score S(S3) to obtain summary information S4. The calculation for the summary priority score S(S3) is as shown in equation (1), where A(S3) represents a data characteristic of the condensed information S3, H(S3) represents a lookup preference of the condensed information S3, and P_{D} represents a type preference of the condensed information S3.

S(S3)=Score(A(S3),H(S3),P_{D}) (1)

The data characteristic (i.e. A(S3)) is, for example, a time length or frequency. The lookup frequency (i.e. H(S3)) is, for example, a reading time or reading frequency obtained from analyzing browsing logs. Refer to FIG. 8 showing a schematic diagram a fuzzy membership function μ(x). In FIG. 8, the horizontal axis represents a reading ratio x, and the vertical axis represents a fuzzy membership function μ(x) (also referred to as a membership grade) having a value between 0 and 1 and representing a degree of truth of a fuzzy set of the reading ratio x. The curve C81 is a fuzzy membership function μ(x) that is read, and the curve C82 is a fuzzy membership function μ(x) that is skipped. The lookup preference (i.e., H(S3))) can be calculated by equation (2) below:

$$\{ \begin{matrix}\begin{matrix}the entire condensed information S ( 3 ) \\ is not looked up , H ( S 3 ) = 0\end{matrix} \\ \begin{matrix}a part of the condensed information S ( 3 ) \\ is read , H ( S 3 ) = 1 \times μ ( x )\end{matrix} \\ \begin{matrix}a part of the condensed information S ( 3 ) \\ is skipped , H ( S 3 ) = - 1 \times μ ( x )\end{matrix} \\ \begin{matrix}the condensed information S ( 3 ) is \\ repeatedly read , H ( S 3 ) = \sum {H ( S 3 )}_{ti}\end{matrix}\end{matrix} \qquad ( 2 )$$

As shown in equation (2) above, when the entire condensed information S3 is not read, the lookup preference (H(S3)) is 0; when the condensed information S3 is read and a part of the contents is read or selected (e.g., three out of ten sets of contents are selected), the lookup preference (i.e., H(S3)) is 1×μ(x); when the condensed information S3 is read and a part of the contents is skipped (e.g., seven out of ten sets of contents are skipped), the lookup preference (i.e., H(S3)) is −1×μ(x); when the condensed information S3 is repeatedly read, the lookup preferences (i.e., H(S3)ₜᵢ) of the reads are summed up as ΣH(S3)ₜᵢ.

The type preference (i.e., P_{D}) can be presented by a weight and be calculated as equation (3) below:

$${W}_{i} = {W}_{i}^{′} + σ \times \frac{\sum H ( S {3}_{i} )}{Num ( S {3}_{i} )} \qquad ( 3 )$$

In equation (3), W_{L} is the weight, S3ᵢ is data, Num(S3ᵢ) is the data count, Wᵢ′ is a historical weight, a is an adjusting parameter, and i is the data type.

$$\frac{\sum H ( S {3}_{i} )}{Num ( S {3}_{i} )}$$

represents the significant level of the i^{th} set of data, and serves as an adjusting parameter for a historical weight (i.e. Wᵢ) to obtain an updated weight (Wᵢ).

The summary priority score S(S3) is calculated according to, for example, equation (4) below:

$$S ( S 3 ) = Score ( A ( S 3 ) , H ( S 3 ) , {P}_{D} ) = α \times {P}_{D} \times ( 1 - \vert H ( S 3 ) \vert ) + A ( S 3 ) = α \times {P}_{D} \times ( 1 - \vert H ( S 3 ) \vert ) + β \times F ( S 3 ) + γ \times L ( S 3 ) \qquad ( 4 )$$

In equation (4), the relationship among α, β and ≡ is, for example but not limited to, α«β»γ, where α is a type priority parameter, β is a frequency priority parameter and γ is a length priority parameter. A(S3)=β×F(S3)+γ×L(S3), where F(S3) is the frequency and L(S3) is the length.

As described above, with the summarization performed by the summary unit 140, the summary information S4 can reflect the reading habit and preference of the user, so as to provide information meeting requirements of the user.

In step S150 in FIG. 3, the display unit 150 displays the summary information S4. When the display unit 150 displays the summary information S4, the display unit 150 presents metaphorical information by a virtual content. For example, a user can select a virtual or metaphorical multimedia as desired for the presentation. For example, classification can be performed according to character expressions (e.g., pleased, angry, sad or happy expressions) and/or actions (eating, sleeping or exercising), and the classified contents are converted on a one-to-one basis after training conducted by means of machine learning or deep learning. For example, a sleeping individual is mapped to a chess playing character, and an exercising individual is mapped to a virtual character using a computer. Further, according to contents of multimedia sounds, the frequency and/or amplitude can be adjusted to convert the sounds to another type of sounds. For example, a speech is converted to robotic sounds, and/or a male voice is converted to a female voice. Alternatively, speech contents can be converted to text by means of the speech-to-text (STT) technology, and then converted back into speech by means of the text-to-speech (TTS) technology, thereby achieving virtual and metaphorical effects.

With the above embodiments, the social network 9000 can initiatively detect, in non-contact and interference-free situations, conditions of social members, and present the conditions of the social members through the condensed information S3 and the summary information S4 in the social network 9000. A virtual character can present activities of the social members by multimedia in virtual scenes, and a user can set a virtual and/or metaphorical multimedia as desired to realize such presentation.

In step S160 in FIG. 3, the correction unit 160 determines, according to feedback information FB, whether the status information S2 needs to be corrected. In step S170 in FIG. 3, the correction unit 160 corrects, according to the feedback information FB, the status information S2 outputted from the analysis unit 120. For example, basic reactions can be different for individuals, and so the automated detection first uses reaction conditions of the general public as the basis for determination. When a user is to feed back with respect to the status information S2, the feedback information FB can be inputted through touch control, speeches, pictures, images or texts. For example, when a user discovers an event that the emotion of a followed social member is changed from neutral to “angry” after Grandmother speaks on the phone with Mary, because Grandmother has a habit of speaking loudly and key terms of the conversation include “careless” and “forgot again”, the above is determined by the analysis unit 120 as the status information S2 indicating “angry”. At this point, the user can select the emotion event to learn more details. After hearing the speeches of the conversation, the user determines that the above information should be a neutral emotion of Grandmother, and can then select by the input unit 180 “angry” and at the same time say “modify to neutral.”

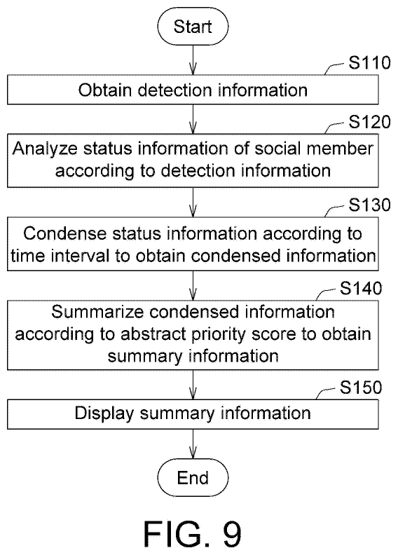

FIG. 9 shows a flowchart of a control method for a social network according to another embodiment. Referring to FIG. 9, the control method for the social network 9000 includes steps S110, S120, S130, S140 and S150. Sequentially, the detection information S1 is obtained in step S110, the status information S2 is obtained from analysis in step S120, the condensed information S3 is obtained in step S130, the summary information S4 is obtained in step S140, and the summary information S4 is displayed in step S150.

With the embodiments above, the social network 9000 is capable of presenting activities (including emotion states, lifestyles, special events, member conversations and/or virtual interactions) of social members in virtual scenes presented by multimedia. These activities can present condensed information thereof by a non-linearly scaled time axis, and can provide summary information according to user preferences.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A control method for a social network, comprising:
obtaining detection information;
analyzing status information of at least one social member according to the detection information;
condensing the status information according to a time interval to obtain condensed information;
summarizing the condensed information according to a summary priority score to obtain summary information; and
displaying the summary information.

2. The control method for the social network according to claim 1, wherein the detection information is a heartbeat frequency, a breathing frequency, a carbon monoxide concentration, a movement path, a body temperature, an image, a speech, an environmental sound, a humidity level or an air quality.

3. The control method for the social network according to claim 1, wherein the detection information is detected by a contact detector.

4. The control method for the social network according to claim 1, wherein the detection information is detected by a non-contact detector.

5. The control method for the social network according to claim 1, wherein the status information is a mental state, a physical state or a special event.

6. The control method for the social network according to claim 1, wherein the condensed information is recorded on a non-linearly scaled time axis.

7. The control method for the social network according to claim 1, wherein the condensed information is presented on a time axis according to an occurrence frequency or duration.

8. The control method for the social network according to claim 1, wherein the summary priority score is obtained according to a data characteristic, a lookup preference and a type preference.

9. The control method for the social network according to claim 8, wherein the data characteristic is determined according to a frequency and a length.

10. The control method for the social network according to claim 8, wherein the type preference is determined according to a significant level of a data type.

11. The control method for the social network according to claim 1, wherein in the step of displaying the summary information, metaphorical information is presented in form of a virtual content.

12. The control method for the social network according to claim 1, further comprising:
correcting the status information according to feedback information.

13. A control system for a social network, comprising:
a detection unit, obtaining detection information;
an analysis unit, analyzing status information of at least one social member according to the detection information;
a condensation unit, condensing the status information according to a time interval to obtain condensed information;
a summary unit, summarizing the condensed information according to a summary priority score to obtain summary information; and
a display unit, displaying the summary information.

14. The control system for the social network according to claim 13, wherein the detection information is a heartbeat frequency, a breathing frequency, a carbon monoxide concentration, a movement path, a body temperature, an image, a speech, an environmental sound, a humidity level or an air quality.

15. The control system for the social network according to claim 13, wherein the detection unit is a contact detector.

16. The control system for the social network according to claim 13, wherein the detection unit is a non-contact detector.

17. The control system for the social network according to claim 13, wherein the status information is a mental state, a physical state or a special event.

18. The control system for the social network according to claim 13, wherein the condensed information is recorded on a non-linearly scaled time axis.

19. The control system for the social network according to claim 13, wherein the condensed information is presented on a time axis according to an occurrence frequency or duration.

20. The control system for the social network according to claim 13, wherein the summary priority score is obtained according to a data characteristic, a lookup preference and a type preference.

21. The control system for the social network according to claim 20, wherein the data characteristic is determined according to a frequency and a length.

22. The control system for the social network according to claim 20, wherein the type preference is determined according to a significant level of a data type.

23. The control system for the social network according to claim 13, wherein the display unit presents metaphorical information in form of a virtual content.

24. The control system for the social network according to claim 13, further comprising:
a correction unit, correcting the status information according to feedback information.
